(19) United States
(12) Patent Application Publication
(10) Pub. No.: US 2011/0184947 A1
(43) Pub. Date: Jul. 28, 2011

(54) INFORMATION PROCESSING APPARATUS, INFORMATION PROCESSING METHOD, AND PROGRAM

(75) Inventor: Ryutaro Watanabe, Tokyo (JP)

(73) Assignee: CANON KABUSHIKI KAISHA, Tokyo (JP)

(21) Appl. No.: 13/006,273

(22) Filed: Jan. 13, 2011

(30) Foreign Application Priority Data
Jan. 26, 2010 (JP) 2010-014310

(51) Int. Cl. G06F 17/30

(52) U.S. Cl. 707/736; 707/E17.014

(57) ABSTRACT

When searching for and printing information from a plurality of portlets, a user must indicate search keywords for each portlet, and the labor increases as the number of portlet increases. Thus, the present invention enables compiling and printing related documents simply by inputting one search term, and the operational labor is thereby reduced. A portal server forms a portal system that manages a portlet server group. In this system, one portlet is defined as the main portlet, and formulae are defined for search terms for each portlet. The portal server searches the main portlet by using one designated search term and extracts related information according to the search term formula for other portlets based on these search results. The extracted search results resulting from searching each portlet using the search term formulae are laid out as one document and print data is produced.

### BACKGROUND OF THE INVENTION

1. Field of the Invention

The present invention relates to an information processing technology that enables production of print data by compiling related information.

2. Description of the Related Art

In recent years, the shifting of software to the Web has been accelerating due to improvements in Web technology and the simplicity of maintenance, and software resources can be used from a computer that can connect to a network. In this situation, portal systems that allow the registration of only functions that are necessary to a user are becoming wide spread. In a portal system, detachable user interface components called “portlets”, which are each functionally independent, are associated within a system framework called a “portal”. Thereby, if a portal system is accessed, a user can simply access all associated portlets without accessing each portlet individually, and is thereby able to use the portlets.

However, each portlet is an independent component, and the actual data for each portlet may be distributed and saved on various portlet servers. Thus, information related to a certain topic cannot be compiled from a plurality of portlets and printed. For example, in a business portal system consisting of portlets for “mail”, “document management”, and “maps”, the user may wish to print “mail about a daily schedule”, “explanatory materials for a business trip destination”, and “maps for lodging” in relation to a business trip. In this case, the user must access each portlet and order the printing of each portlet.

Thus, in conventional technology, the user instructs the system to execute a search by setting different search keywords for each search destination for each information type, and carries out the layout and printing of each search result as one document (refer to Japanese Laid-Open Patent Application No. 2002-202991). Thereby, the work of compiling a plurality of documents into one document is eliminated, and the operability can be improved.

In the conventional technology, search keywords must be set for each search destination by a user operation. That is, because a user must designate the optimal keywords for each search destination, the operational burden on the user increases when the number of search destinations increases.

Thus, the present invention provides an information processing apparatus by which printed material that the user desires can be obtained easily without increasing the operational burden on the user, and an information processing method and program.

### SUMMARY OF THE INVENTION

In order to resolve this situation, the apparatus according to the present invention is an information processing apparatus that manages a plurality of applications as portlets on a server and produces print data for documents related to the designated search terms, including a definition unit that defines one among a plurality of portlets as a main portlet, a search unit that searches portlets other than the main portlet based on the search results for the main portlet, and a production unit that produces print data based on search results for the main portlet and search results for portlets other than the main portlet obtained by the search unit.

According to the present invention, a user can compile and print a plurality of documents without setting search terms for each portlet of a search destination, and the operational burden can be reduced.

Further features of the present invention will become apparent from the following description of exemplary embodiments (with reference to the attached drawings).

### BRIEF DESCRIPTION OF THE DRAWINGS

FIG. 1 is a drawing that shows an example of a configuration of a system according to an embodiment of the present invention.

FIG. 2 is a drawing that shows an example of a configuration of a portal server.

FIG. 3 is a drawing that shows an example of a configuration of a portlet server.

FIG. 4A is a drawing that shows an example of a screen configuration for a portal system for explaining the first embodiment of the present invention, in conjunction with FIG. 5 to FIG. 11.

FIG. 4B is a drawing that shows an example of a screen configuration for a print portlet for explaining the first embodiment of the present invention, in conjunction with FIG. 5 to FIG. 11.

FIG. 5A is a drawing that shows an example of a screen configuration for a mail portlet.

FIG. 5B is a drawing that shows an example of a screen configuration for a map portlet.

FIG. 5C is a drawing that shows an example of a screen configuration for a document management portlet.

FIG. 6A is a drawing that shows an example of definition information for a main portlet.

FIG. 6B is a drawing that shows an example of search results for a main portlet.

FIG. 7 is a flowchart exemplifying the flow of search result analysis processing for a main portlet.

FIG. 8 is a flowchart that exemplifies the flow of search processing for a portlet.

FIG. 9A is a drawing that exemplifies definition information and search keyword information in a search term formula.

FIG. 9B is another drawing that exemplifies definition information and search keyword information in a search term formula.

FIG. 10A is a drawing that exemplifies search result information for a portlet.

FIG. 10B is another figure that exemplifies search result information for a portlet.

FIG. 11 is a drawing that shows an example of print data.

FIG. 12A is a drawing that exemplifies an operation screen that includes print data and a switching function for explaining a second embodiment of the present invention.

FIG. 12B is a drawing that exemplifies the switching instruction button for explaining the second embodiment of the present invention.

FIG. 13 is a flowchart that exemplifies the flow of a switching process for search results.

### DESCRIPTION OF THE EMBODIMENTS

Below, each embodiment of the present invention is explained with reference to the figures. Note that in the present specification, the term “portal server” denotes a server for a system that aggregates and displays each application on one Web system as a portlet in order to efficiently use various applications that are distributed, for example, within a corporation. In addition, the term “portlet” denotes a detachable user interface (below, abbreviated “UI”) component that is managed and displayed on a portal server.

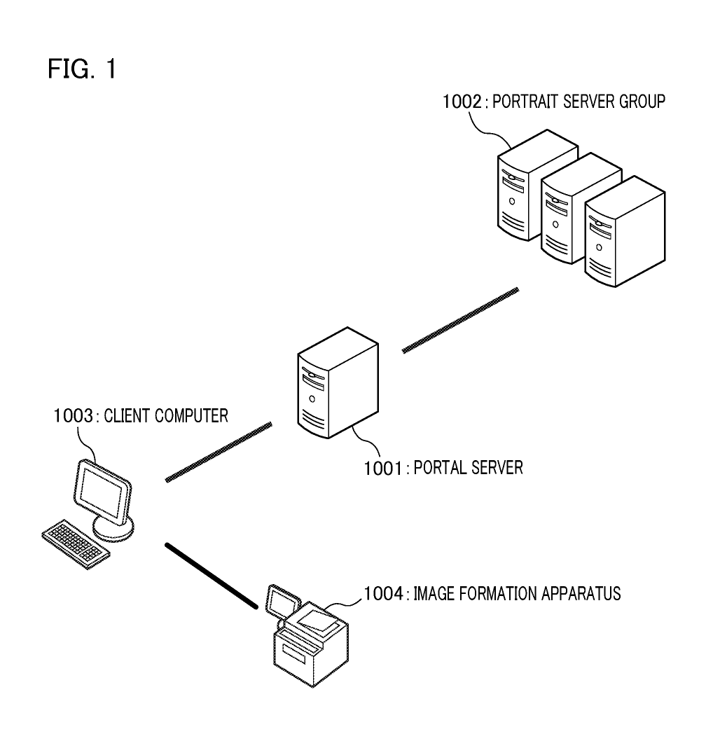

The information processing system according to the present embodiment is a portal system that can search for information in each portlet based on a designated search terms, and can compile and print the related information. For example, in the present system, based on one keyword, this system obtains information related thereto from each portlet, and the plurality of obtained information is compiled to produce print data for printing. For plural portlets that are registered in this portal system, a formula that includes search terms is defined when searching each portlet. In addition, one among the registered portlets is defined as the “main portlet”. When search terms (below, also referred to as “keywords”) are input by a user operation, the portal server (refer to 1001 in FIG. 1) carries out a search using the input terms in a portlet server of the main portlet, which includes the corresponding applications. In addition, the portal server 1001 analyses the information that has been obtained from the portlet server as search results, and confirms whether or not a term in a formula defined as the search term formula for each portlet other than the main portlet is included in the search results for the main portlet. In the case in which a term of a specific formula is included in the search results for the main portlet, search processing is executed on the corresponding portlet server by using this term. The portal server 1001 produces print data, which is based on the information obtained from each portlet and information initially obtained by the search of the main portlet, as search results.

FIG. 1 is a drawing that shows an example of a system configuration according to an embodiment of the present invention, and the portal system is configured by a portal server 1001, a portlet server group 1002, a client computer 1003, and an image forming apparatus 1004.

The portal server 1001, which provides the service of the portal system, is connected to a portlet server group 1002 and a client computer 1003 via a network. The portal portlet group 1002 provides application functions and includes storage that stores the application data. For example, applications that provide mail functions described below and applications that provide map information are stored in one of the portlet server groups. The client computer 1003 is used in order for the user to access the portal system. The image formation apparatus 1004 is connected to the client computer 1003, and receives and prints print data. The server, computer, and image formation apparatus are formed by a CPU (central processing unit), and storage devices such as RAM (random access memory), ROM (read only memory) and an HDD (hard disk drive). Note that the processing explained below is realized by a CPU interpreting and executing programs stored on the computers that form the portal server 1001, the portlet server group 1002, the client computer 1003, or the image formation server 1004.

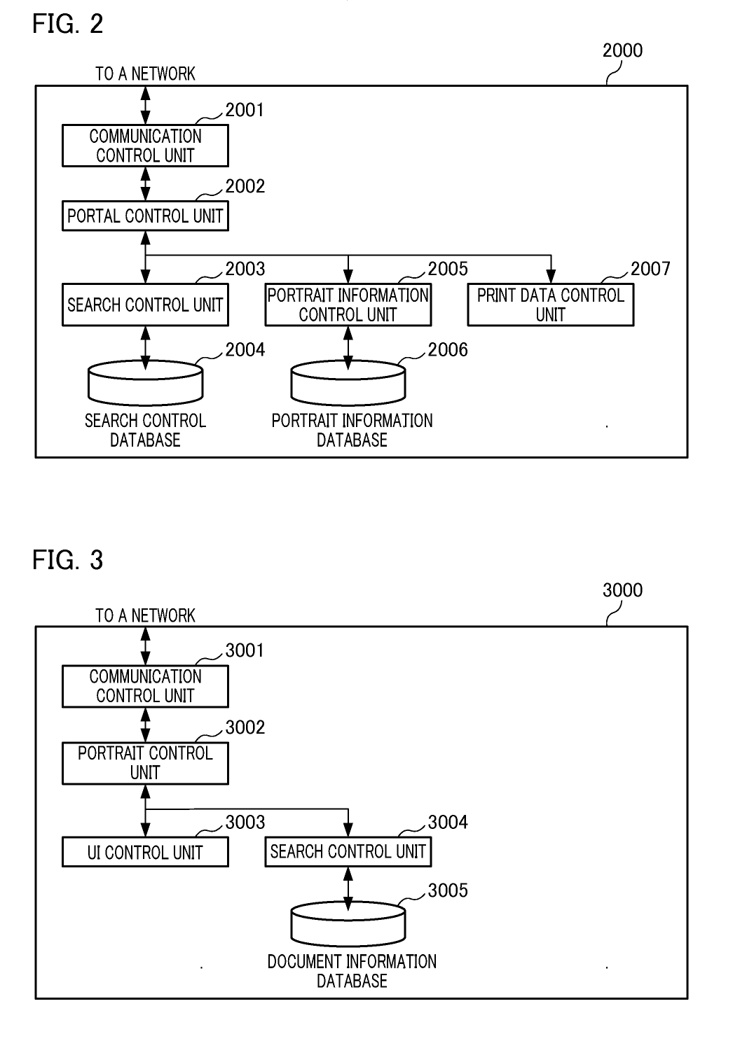

FIG. 2 is a block diagram that shows an example of the system configuration 2000 of a portal server 1001. The communication control unit 2001 exchanges information with the portlet sever group 1002 and the client computers 1003 via a network according to the instructions of a portal control unit 2002.

The portal control unit 2002 controls the communication control unit 2001, the search control unit 2003, the portlet information control unit 2005, and the print data control unit 2007, and controls the processing in the portal server. The portal control unit 2002 controls the search of the main portlet that uses the search terms designated by the user operation in the client computer 1003 and the search of each portlet and the search of each portlet following the search term formula. That is, the portal control unit 2002 transmits search terms that have been designated by a user to a portlet server that includes an application corresponding to the main portlet, and obtains the information corresponding to the search terms from the portlet server as search results. In addition, based on the search results for the main portlet, search processing for each portlet other than the main portlet is carried out by extracting search terms according to the formulas that have been defined for each portlet. The details of the processing will be explained below.

The search control unit 2003 carries out the exchange of information with the search control database 2004 according to the instructions of the portal control unit 2002, and carries out the control of search processing, such as extracting search terms and distinguishing search target portlets, and the analysis of search results from the portlet server. The search control database 2004 stores information related to searches, such as search term formulae for each portlet and definitions of the main portlet and the like, and carries out storage and providing of information according to the instructions of the search control unit 2003. That is, in the search control database 2004, one among the plurality of portlets is defined as the main portlet, and search term formulae are defined for each portlet.

The portlet information control unit 2005 carries out exchanges of information with the portlet information database 2006 according to the instructions of the portal control unit 2002, and carries out control of the portlet information, including, for example, the obtaining, adding, and deleting of portlets. The portlet information database 2006 stores information related to the portlets, including, for example, a list of registered portlets, and carries out the storage and providing of information according to the instructions of the portlet information control unit 2005.

The print data control unit 2007 carries out control of the print data, including, for example, printing layout and data production, according to the instructions of the portal control unit 2002. That is, the print data control unit 2007 combines the search results for each portlet to produce print data, and sends the print data from the communication control unit 2001 to the client computer 1003 via a network.

FIG. 3 is a block drawing that shows an example of the system configuration 3000 of the portlet server group 1002 that provides the application functions.

The communication control unit 3001 carries out the exchange of information with the portal server 1001 via a network according to instructions of the portlet control unit 3002. The portlet control unit 3002 controls the communication control unit 3001, the UI control unit 3003, and the search control unit 3004, and controls the processing of the portlet server.

The UI control unit 3003 carries out UI control, such as generation of the UI screen data according to the instructions of the portlet control unit 3002. The search control unit 3004 provides search functions for document information in a portlet according to the instructions of the portlet control unit 3002. That is, in the case in which a search term designated by a user is received from the portal server 1001, the search control unit 3004 of the portlet server searches for information corresponding to this search term. The document information database 3005 carries out storage and providing of document information according to the instructions of the search control unit 3004.

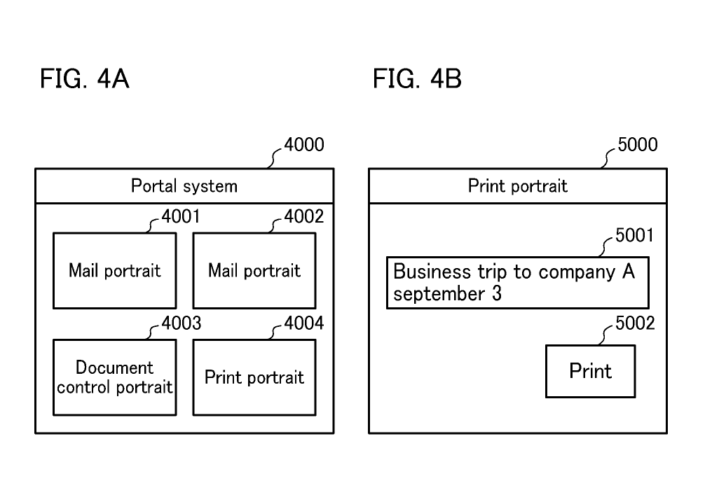

Next, the configuration of the portal system according to the present embodiment will be explained. First, with reference to FIG. 4A and FIG. 4B, an overview of the portal system will be explained. The main screen 4000 in FIG. 4A shows an example of a main screen for the portal system, and this is a UI screen displayed in the case in which the portal server 1001 has been accessed from a client computer 1003. The data generated by the portal server 1001 is sent to the client computer 1003, and an image is displayed on the display unit thereof. While the user is viewing the screen, various types of portal operations such as mail viewing and transmitting, and the management of documents, and printing instructions using keywords, can be carried out.

The main screen 4000 of the portal system is formed by display areas that respectively show a plurality of portlets, and in the present example, display areas 4001 through 4004 are shown. Display areas 4001 to 4003 show application portlets. In the present example, the display area 4001 shows a mail portlet, display area 4002 shows a map portlet, and display area 4003 shows a document management portlet. These portlets are software that is operated on the portlet server group 1002, and provides the functions of the display of mail, the display of maps, and document management. The display area 4004 shows a print portlet, and is software that operates on the portal server 1001. This provides a layout production function and the like by compiling information to be printed based on the input keywords. The display screen 5000 in FIG. 4B displays an example of a screen for a print portlet, and includes a text input field 5001 in which a user inputs all together keywords for which printing should be carried out, and an instruction button 5002 for directing the execution of the printing processing.

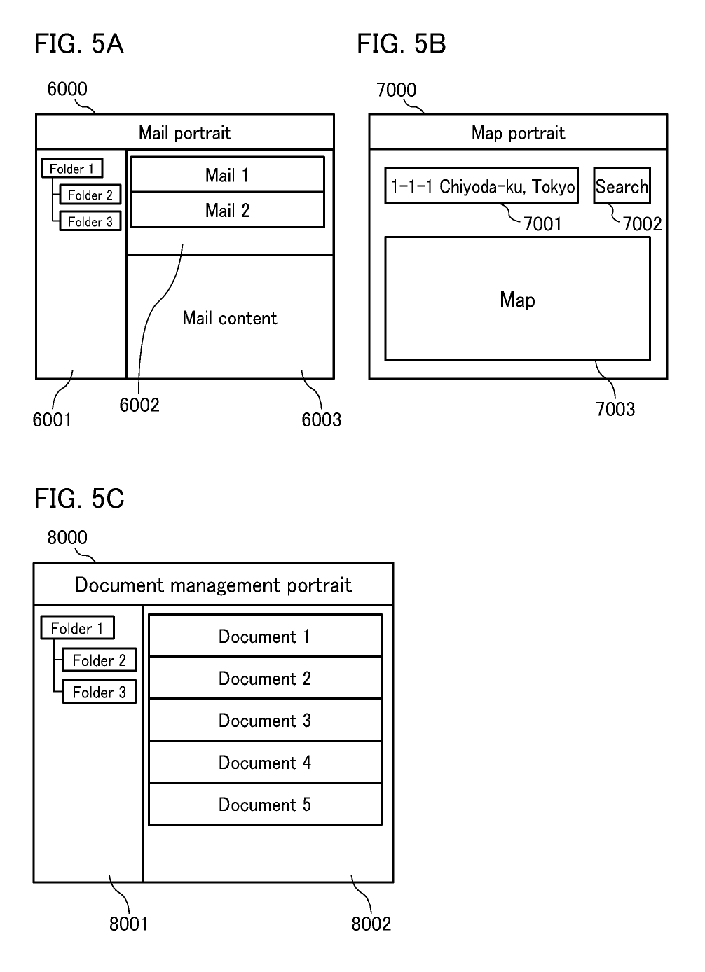

FIG. 5A to FIG. 5C show an example of the screen configuration for a mail portlet, a map portlet, and a document management portlet as examples of application portlets. The display screen 6000 in FIG. 5A is an example of a screen for a mail portlet. This includes a view display area 6001 for a folder tree that displays the mail storage folder, and a mail list display area 6002 is provided that displays as a list email in the folder that has been selected in this area. Below this, a mail content display area 6003 that displays the content of the email that has been selected in the mail list display area 6002 is positioned.

The display screen in 7000 in FIG. 5B is an example of a screen for a map portlet. A text field 7001 for inputting an address that appears in a map the user wishes to display and, on the right side thereof, an instruction button 7002 that executes a search of the map are disposed in the screen. Below these, a map display area 7003 that displays the map to be retrieved is disposed.

The display screen 8000 in FIG. 5C is an example of a screen for a document managing portlet. A view display area 8001 for a folder tree that displays folders storing document files and a document list display area 8002 that displays a selected document list in a folder in the display area 8001 are disposed in the screen.

### First Embodiment

Next, the processing in the first embodiment of the present invention will be explained. First, the search processing according to the main portlet, that is, processing that obtains search results from the main portlet based on keywords that have been input by a user, will be explained. First, access to the portal server 1001 from the client computer 1003 is carried out according to the user's operating instructions. The portal server 1001 that has received an access request from the client computer 1003 produces data for the main screen 4000 (refer to FIG. 4A) of the portal system. The client computer 1003 that has received data for the main screen 4000 of the portal system displays the main screen 4000 of the portal system. Then the user directs the execution of printing by inputting a keyword for which printing is to be carried out on the screen of the print portlet of the display screen 5000 (refer to FIG. 4B). In the present example, the keywords “business trip to Company A September 3” are input to the text input field 5001, and the instruction button 5002 is pressed.

The portal server 1001 that has received the print instruction executes the following processes:
(1) Acquisition processing for designated search terms;
(2) Recognition processing of the main portlet; and
(3) Search processing on the main portlet and acquisition of the search results.

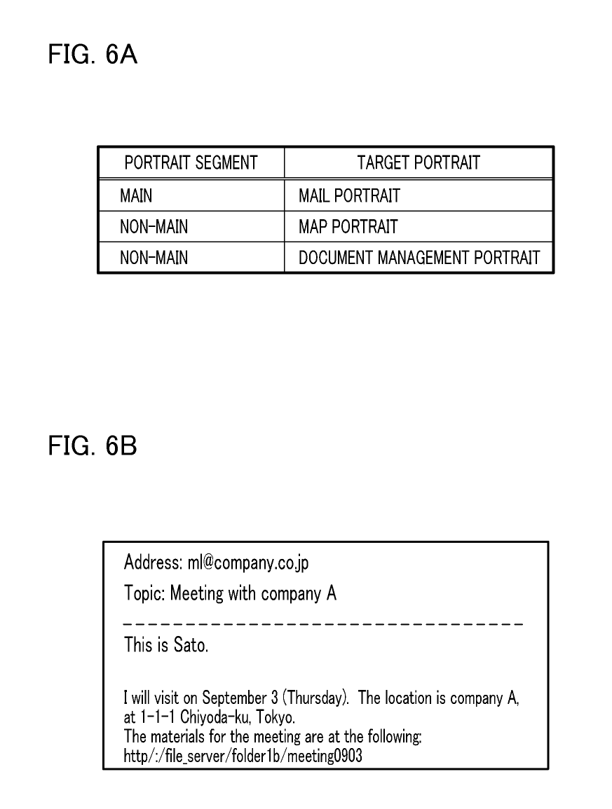

In (1), the portal server 1001 acquires information about keywords that a user has input to the text input field 5001. Next, in (2), the portal server 1001 acquires the definition information for portlet segments from the search control database 2004 via the search control unit 2003. FIG. 6A shows, in the form of a TABLE, an example of the definition information for portlet segments that is stored in the search control database 2004. In the present example, there are two types, “main” and “non-main”, shown in the column labeled “portlet Segment”, but these are definition information for identifying which among the plurality of application portlets is defined as a main portlet. In addition, in the column labeled “Target Portlet”, “mail portlet”, “map portlet”, and “document management portlet” are shown. In the first line, because the target portlet “mail portlet” is defined as “main” in the portlet segment, the portal server 1001 can recognize “mail portlet” to be a main portlet. In “map portlet” in the second line and “document management portlet” in the third line, the portlet segment is defined as “non-main”. Referring to such definition information, the portal server 1001 notifies the portlet server, in which the portlet segment provides the portlet defined by “main”, about the search term, and acquires information that matches this search term. Note that the Portlet Segment and the Target Portlet names may be ID information that can be unambiguously identified. In addition, the definition information for a portlet can be defined by the system builder when building this system, or can be changed by the user at any arbitrary timing.

In (3), the portal server 1001 carries out a search of the keywords “business trip to Company A September 3” input by the user in the portlet (in the present example, the mail portlet) that the portlet segment has been identified as being “main”, and obtains the search results. FIG. 6B shows mail information consisting of a mail address, topic, and body (including the date and the time, address, and URL) as an example of the search results.

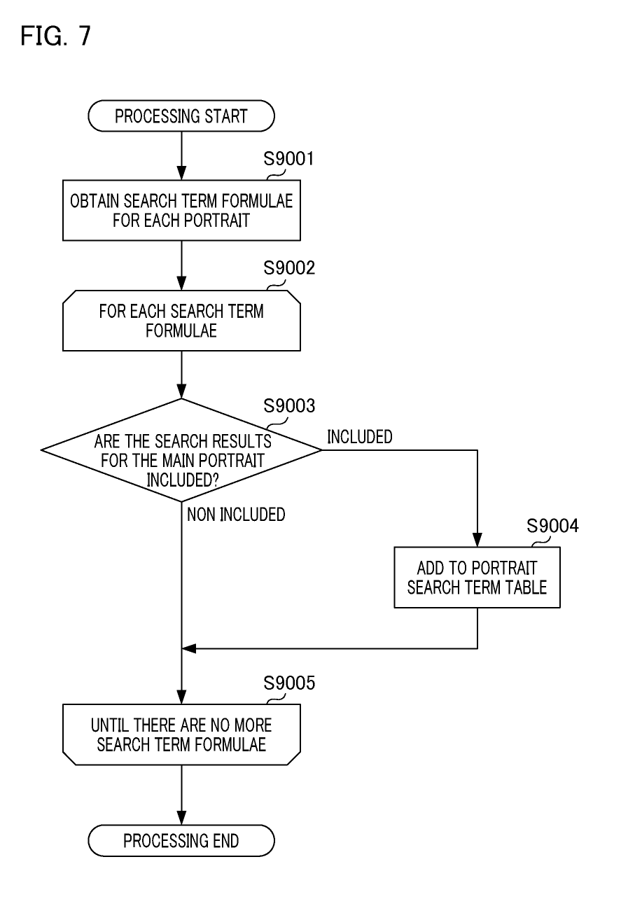

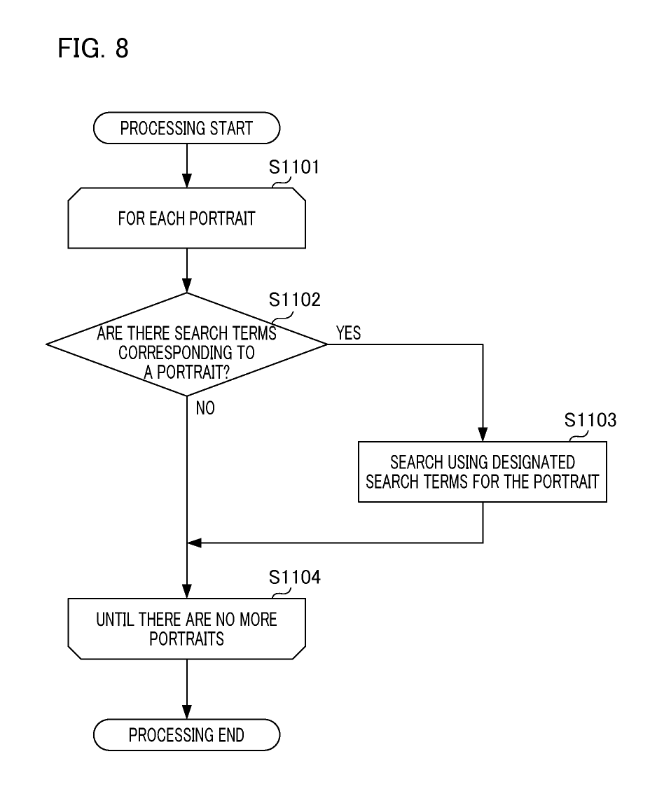

The portal server 1001 that has received the search results for the main portlet searches other portlets to obtain necessary information. Below, this process will be explained with reference to the flowcharts in FIG. 7 and FIG. 8.

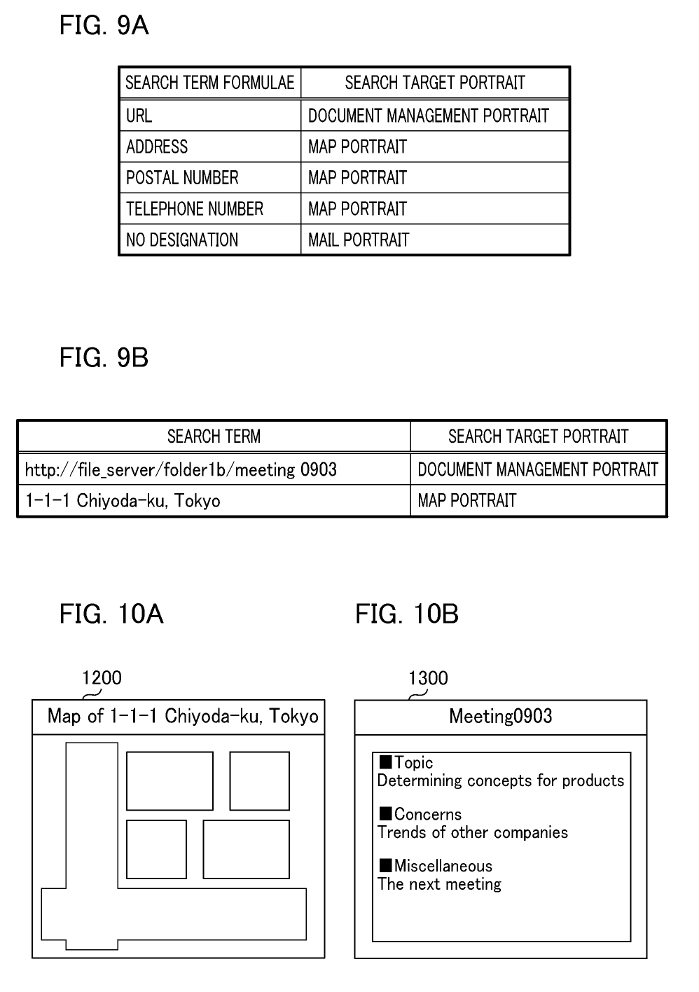

First, in S9001 of FIG. 7, the portal server 1001 acquires the definition information of the search term formula for each portlet from the search control database 2004 via the search control unit 2003. An example of the definition information for a search term formula stored in the search control database 2004 is shown in FIG. 9A. In the column labeled “Search Term Formula”, “URL (Uniform Resource Locator)”, “address”, “postal number”, “telephone number”, and “no designation” are illustrated. In addition, in line 1 of the column labeled “Search Target Portlet”, “document management portlet” is illustrated, in line 2 to line 4, “map portlet” is illustrated, and in line 5, “mail portlet” is illustrated. In the present example, “document management portlet” shows that a search is carried out with the keyword in a “URL” format, and “map portlet” shows that a search is being carried out by keywords in each of the formats for an “address”, a “postal number”, and a “telephone number”. Note that the search term format and the search target portlet name may be ID information that can be unambiguously identified. In addition, the definition information of the search term format can be defined by the person who builds the system during system building, and can be changed by the user at any arbitrary timing.

Next, the portal server 1001 repeats the processing shown in S9002 to 9005 on each of the search term formulae obtained in S9001 of FIG. 7. In S9002, iterative processing begins, and in S9003, the portal control unit 2002 of the portal server 1001 determines whether or not the data of the relevant search term formulae is included in the search results for the main portlet. When explained specifically using the search results shown in FIG. 6B as an example, the search processing for the search term formula of the first line in FIG. 9A, that is, the URL format, is executed. As a result, “http://file_server/folder1b/meeting0903” is extracted from the search results for the main portlet of FIG. 6B as a term for the URL format. In the case in which it has been determined that the search term formula is included in the search results for the main portlet, the processing proceeds to S9004. Here, the portal control unit 2002 uses the term extracted at S9003, adds the portlet associated with the term formula to the portlet search term table, and the processing then proceeds to S9005. An example of the portlet search term table is shown in a table format in FIG. 9B. The data for “http://file_server/folder1b/meeting9030” that has been extracted is added to the column labeled “Search Term”, and the “document management portlet” corresponding thereto is shown in the column labeled “Search Target Portlet”.

In contrast, in S9003, in the case in which it has been determined that the data for the search term formula is not included in the search results for the main portlet, and the processing proceeds to S9005 and continues for the next search term formula. That is, the processing returns to S9002, the search processing for the address format is carried out. As a result, “1-1-1 Chiyoda-ku, Tokyo” is extracted. This data is also added to the portlet search term table in FIG. 9B, and the “map portlet” corresponding thereto is shown in the column labeled “Search Target Portlet”. In this manner, in the case in which the data for the search term formula is included in the search results for the main portlet, the processing of S9004 is executed for all of the search term formulae that are shown in FIG. 9A. In addition, when there are no more search term formulae that are an object, the processing describe above ends.

Next, the portal server 1001 executes the processing in S1101 to S1104 in FIG. 8 on all portlets other than the main portlet. That is, in S1101, when iterative processing is started, first in S1102, the portal server 1001 determines whether or not there is a search term corresponding to the portlet. Specifically, the portal server 1001 searches for a search term in the portlet search term table that is exemplified in FIG. 9B. As a result, in the case in which a search term is not found, the process proceeds to S1104, and the processing is continued on the next portlet. In addition, in the case in which a search term is found, the process moves to S1103, search processing is carried out on the target portlet using the discovered search term, and the portal server 1001 obtains the search results from the portlet. For example, in the case in which the portlet that is the search object is the document managing portlet, the portal server 1001 carries out a search by using “http://file_server/folder1b/meeting0903”, which is the search word for the document management portlet. An example of the search results is shown in FIG. 10A and 10B. The search results 1200 in FIG. 10A show the map information for “1-1-1 Chiyoda-ku, Tokyo” that was obtained by searching the map portlet using “1-1-1 Chiyoda-ku, Tokyo”. Specifically, the portal server 1001 reports “1-1-1 Chiyoda-ku, Tokyo” to the portal server. As a result, the portal server 1001 reports the map information for “1-1-1 Chiyoda-ku, Tokyo” to the portlet server as search results, and thus, FIG. 10A is obtained. In addition, the search results 1300 in FIG. 10B show the document data for “meeting0930” that was obtained by searching the document management portlet using “http://file_server/folder1b/meeting0903”.

Next, the layout and printing processing for the search results is executed. The portal server 1001 lays out the information that has been obtained as search results, and generates print data. That is, the portal server 1001 lays out the search results (refer to FIG. 6B) obtained from the main portlet and the search results (refer to FIG. 10A and FIG. 10B) obtained from each portlet, and generates print data using the print data control unit 2007.

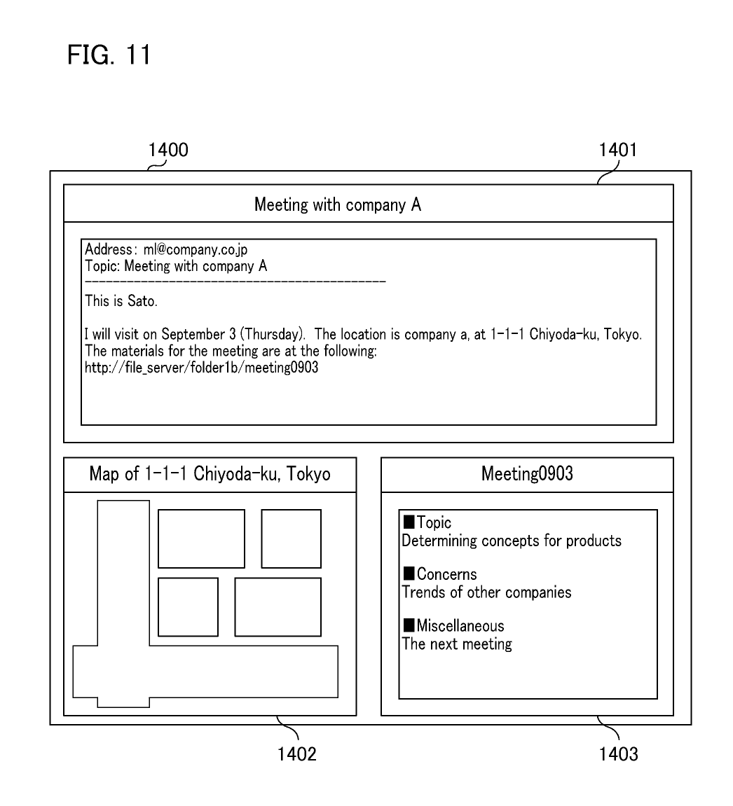

FIG. 11 shows the print layout screen 1400 obtained by using the print data. In the present example, a print layout screen is shown that has been obtained by combining and laying out search results 1401 of the main portlet and the search results 1402 and 1403 in each portlet. The search results 1401 of the main portlet correspond to the results retrieved from the mail portlet by using the keyword “business trip to company A on September 3”, which has been input by a user, that is, correspond to the mail data shown in FIG. 6B. The search results 1402 for a portlet correspond to the results 1200 of searching a map portlet using the keyword “1-1-1 Chiyoda-ku, Tokyo”, which was extracted from the search results of the main portlet, that is, correspond to the map data in FIG. 10A. The search results 1403 correspond to the results 1300 retrieved from the document management portlet by using the keyword “http://file_server/folder1b/meeting0903”, which was extracted from the search results for the main portlet, that is, correspond to the document data in FIG. 10B. Note that in the present example, two search results for portlets were explained, but the search results of the portlets to be laid out change depending on the search results of the main portlet, the number of the extracted keywords, and the search term formula that is defined by the each portlet. The portal server 1001 generates print data in order to output printed matter of the print layout screen 1400 in FIG. 11.

The print data that has been produced by the print data control unit 2007 of the portal server 1001 is transmitted to the client computer 1003 via the communication control unit 2001. The client computer 1003 that has received the print data from the portal server 1001 displays the print data on the display unit thereof. The user confirms the displayed print data and directs the execution of the printing, and the print data is printed by the image forming apparatus 1004.

According to the first embodiment, simply using an operation in which one search term is input and without separately setting a search term for each portlet, a user can compile and print information related the search term. Therefore, the labor in terms of print operations can be reduced.

Note that in the first embodiment, in the case in which, for example, a plurality of information sets is retrieved as search results using a search term that has been input by a user, only information that includes much recent information or many search terms may be reported to the portal server as search results.

### Second Embodiment

Next, a second embodiment of the present invention will be explained. In the second embodiment, a portal system is provided in which, as described above, in the case in which the print data that has been laid out differs from the result desired by the user, by the user selecting suitable data to correct the layout, a desired print result can be obtained. Note that because the structure of the system and each of the servers and the processes of each of the software are identical to those in the first embodiment, below, the explanation will focus on the points of difference.

In the first embodiment, in the flow of processing up to the layout related to the search results of the portlet and the generation of the print data, the portal serer 1001 receives one result for the search results for each portlet that the portal server 1001 has received. These search results undergo layout processing, and one set of print data is generated. In contrast, in the second embodiment, in the case in which search results for a main portlet and search results for other portlets are received by the portal server 1001, a plurality of candidate data sets is received. That is, the user can obtain the intended printing results by selecting desired data from a plurality of candidate data.

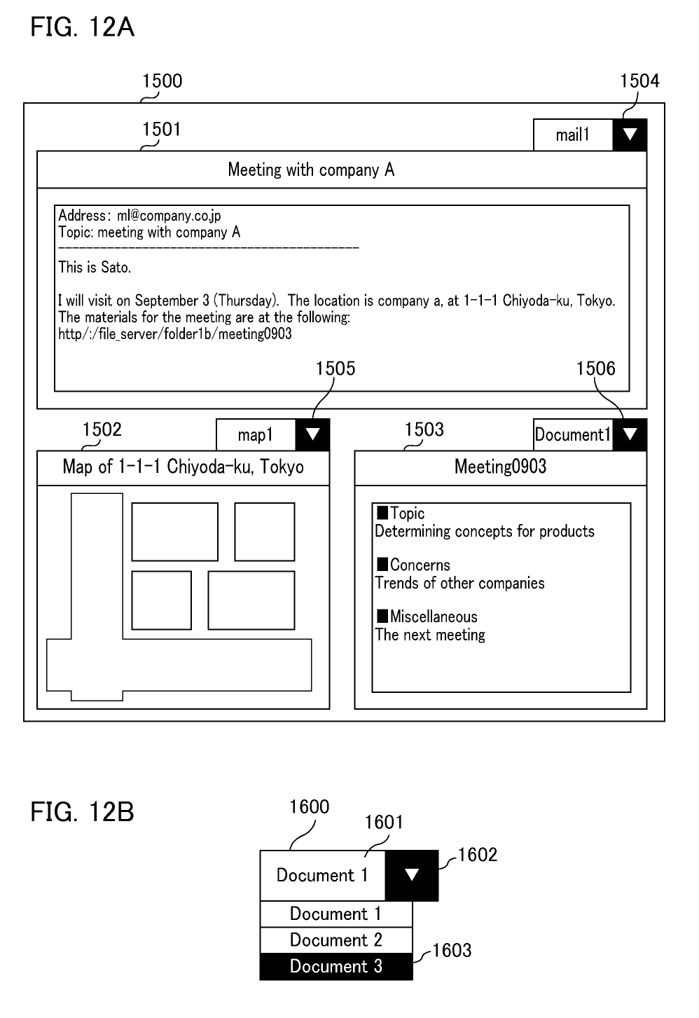

FIG. 12A shows a display example for a print layout screen, and in the second embodiment, when a print layout screen is displayed to a user, an operation screen that includes a switching function for the search results for which layout has been completed is presented. In the present example, when the portal server 1001 lays out the search results, switching instruction buttons (refer to 1504 to 1506) for switching the search results candidates are disposed by being appended to each of the search results. The print layout screen 1500 includes the search results 1501 for the main portlet and the search results 1502 and 1503 of each of the portlets. The instruction buttons 1504 to 1506 are respectively switching instruction buttons that correspond to the search results 1501 to 1503. That is, the difference between the present example and the print layout screen 1400 that is shown in FIG. 11 is that switching instruction buttons 1504 to 1506 are provided so that a user can select desired search results from a plurality of candidates among the search results. As shown in the example of the switching instruction button 1600 in FIG. 12B, this button includes a selected result display area 1601, result change instruction button 1602, and candidate list 1603. The select result display area 1601 is a area for displaying the current selected result “document 1”, and the result change instruction button 1602 on the right side is a button that a user operates when carrying out a change of display candidates. When the user operates the result change instruction button 1602, the selection choices “document 1”, “document 2”, and “document 3” are displayed in the candidate list 1603, and the user can confirm the content by selecting and displaying the desired data.

Next, the switching process for the layout results will be explained. When the operation of the result change instruction button 1602 is carried out, the portal server 1001 carries out the regeneration of print data according to this switch instruction. That is, the user operates any one of the switching instruction buttons 1504 to 1506 on the print layout screen 1500, and indicates the switch of the laid out search results to the portal server 1001.

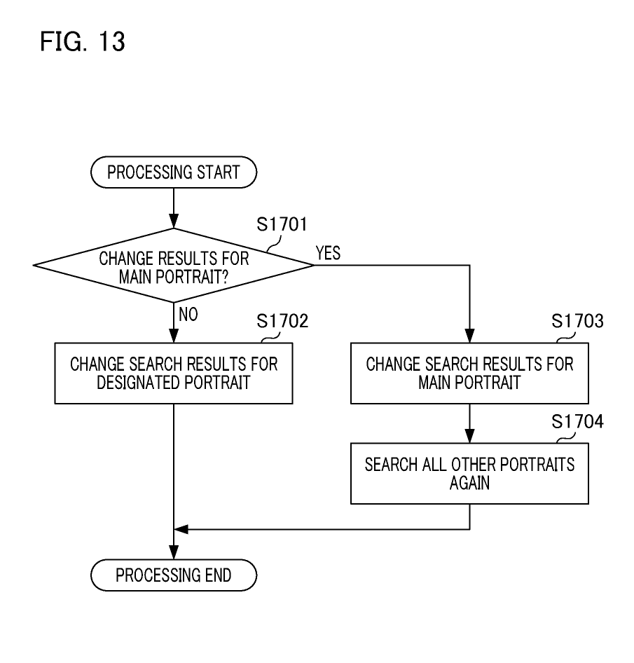

The flowchart in FIG. 13 shows the flow of the change process for search results that is executed by the portal serer 1001 that has received a switch instruction. First, in S1701, the portal control unit 2002 determines whether the search results on which the switch instruction is to be carried out are search results for the main portlet or are search results for the other portlets. Specifically, S1701 is realized by determining whether sections of indicated portlets are main or non-main in FIG. 6.

As a result, in the case in which a switch instruction is carried out on search results of the other portlets, the processing proceeds to S1702. Here, the search results subject to the switch instruction are changed to a search result of the newly designated portlet, and the print data control unit 2007 regenerates the print data by using the search results that have been interchanged according to the instruction, and the processing ends.

In contrast, in the case in which a switch instruction is carried out on the search result of a main portlet, the processing proceeds to S1703, and the search results that have been subject to the switch instruction are changed to the search results designated in the candidate list 1603. Then the process proceeds to S1704, and the portal control unit 2002 uses the search results of the changed main portlet and searches all of the other portlets again. Similar to the case of the first embodiment, this process is executed according to a search sequence (refer to FIG. 8) for other portlets. Then, when the new search of all portlets excluding the main portlet has ended, a print layout based on the search result is regenerated, and the process ends.

According to the second embodiment, even in the case in which the search results that are initially laid out by the portal system are not the print data intended by the user, the user is not forced to reenter keywords. That is, the user can select desired candidates from a plurality of search results, and until the intended data is obtained, can change print data without the labor of reentering keywords any number of times. Thereby, the difficulties for the user that occur until the final print results have been obtained can be reduced, and the usability increased.

### OTHER EMBODIMENTS

In addition, the present invention is also realized by executing the following process. Specifically, the present invention is a process in which software (program) that realizes the functions of the embodiments described above is provided to a system or apparatus via a network or various types of storage media, and a computer (or a CPU or MPU or the like) for this system or apparatus reads and executes the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-014310 filed Jan. 26, 2010 which is hereby incorporated by reference herein in its entirety.

What is claimed is:

1. An information processing apparatus that manages a plurality of applications on a server as portlets and produces print data for documents related to designated search terms, comprising:
a definition unit configured to define one among the plurality of portlets as the main portlet;
a search unit configured to search the main portlet using the search terms and searches the portlets other than the main portlet based on the search results for the main portlet; and
a production unit configured to produce print data based on the search results for the main portlet and the search results of portlets other than the main portlet that have been obtained by the search unit.

2. An information processing apparatus according to claim 1, further comprising a storage unit configured to store search term formulae for portlets other than the main portlet, wherein
the search unit uses the search terms of the search term formulae included in the search results for the main portlet to search the portlets other than the main portlet.

3. An information processing apparatus according to claim 1, wherein the production unit displays an operation screen that includes switch instruction button that enables selecting search results for each portlet for print data, and changes to the data of search results selected by a user operation.

4. An information processing apparatus according to claim 1, wherein the storage unit stores search term formulae for each portlet and definition information for segments of portlets, and
the search unit searches the main portlet and portlets other than the main portlet by obtaining the search term formulae for each of the portlets and segments for the portlets.

5. An information processing method that manages a plurality of applications on a server as portlets and produces print data for documents related to the designated search terms, the method consisting of:
defining, in a definition step, one among the plurality of portlets as a main portlet;
searching, in a search step, the main portlet using the search terms and searching portlets other than the main portlet based on search results for the main portlet; and
producing, in a production step, print data based on the search results for the main portlet and the each results for the portlets other than the main portlet that have been obtained in the search step.

6. A recording medium on which computer programs are recorded that manage a plurality of applications on a server as portlets and that produce print data for documents related to designated search terms, wherein the computer program causes a computer to execute:
defining, in a definition step, one among the plurality of portlets as a main portlet;
searching, in a search step, the main portlet using the search terms and searching portlets other than the main portlet based on search results for the main portlet; and
producing, in a production step, print data based on the search results for the main portlet and the each results for the portlets other than the main portlet that have been obtained in the search step.
